(19) United States
(12) Patent Application Publication
(10) Pub. No.: US 2023/0206661 A1
(43) Pub. Date: Jun. 29, 2023

(54) DEVICE AND METHOD FOR AUTOMATICALLY GENERATING DOMAIN-SPECIFIC IMAGE CAPTION BY USING SEMANTIC ONTOLOGY

(71) Applicant: KOREA ADVANCED INSTITUTE OF SCIENCE AND TECHNOLOGY, Daejeon (KR)

(72) Inventors: Ho Jin Choi, Daejeon (KR); Seung Ho Han, Daejeon (KR)

(21) Appl. No.: 17/920,067

(22) PCT Filed: Dec. 28, 2020
(86) PCT No.: PCT/KR2020/019203

§ 371 Date: Oct. 20, 2022

(30) Foreign Application Priority Data
Apr. 23, 2020 (KR) 10-2020-0049189

(51) Int. Cl. G06V 20/70; G06F 40/166; G06V 10/82

(52) U.S. Cl. CPC G06V 20/70; G06F 40/166; G06V 10/82

(57) ABSTRACT

An apparatus for automatically generating a domain-specific image caption using a semantic ontology is provided. The apparatus includes a caption generator configured to generate an image caption in the form of a sentence describing an image provided from a client, in which the client includes a user device, and the caption generator includes a server connected to the user device through a wired/wireless communication method.

### CROSS-REFERENCE TO RELATED APPLICATIONS

This application claims priority to PCT Application No. PCT/KR2020/019203, having a filing date of Dec. 28, 2020, which claims priority to KR 10-2020-0049189, having a filing date of Apr. 23, 2020, the entire contents both of which are hereby incorporated by reference.

### FIELD OF TECHNOLOGY

The following relates to an apparatus and method for automatically generating a domain-specific image caption using a semantic ontology, and more particularly, to an apparatus and method for automatically generating a domain-specific image caption using a semantic ontology capable of finding object information and attribute information in a new image provided by a user and using the found object information and attribute information to generate a natural language sentence describing the image.

### BACKGROUND

In general, image captioning involves generating a natural language sentence describing an image given by a user. Before the development of various technologies related to artificial intelligence, image captioning was performed directly by humans. In recent years, however, with the increase in computing power and the development of artificial intelligence technologies such as machine learning, a technology for automatically generating captions using a machine has been under development.

The existing automatic caption generation technology involves searching for images having the same label using many existing images and information on labels (that is, one word describing an image) attached to each image or attempting to assign labels of similar images to one image to describe the image using a plurality of labels.

The background technology of embodiments of the present invention are disclosed in Korean Patent No. 10-1388638 (registered on Apr. 17, 2014, annotating images).

The background technology describes finding one or more nearest neighbor images, in which input images and image labels are related to each other, in a set of stored images, annotating each selected image by assigning labels of each selected image from multiple labels for the input images, extracting features of all images for the nearest neighbor images related to the input images, calculating a distance between the respective extracted features by learning a distance derivation algorithm, and finally, generating the multiple labels related to the input images. Since the background art is a method of simply listing words related to images, rather than forming annotations for the generated images in the form of complete sentences, the background technology may not be considered as a description in the form of a sentence for a given input image, nor is the background technology considered as a domain-specific image caption.

### SUMMARY

An aspect relates to an apparatus and method for automatically generating a domain-specific image caption using a semantic ontology, and more particularly, to an apparatus and method for automatically generating a domain-specific image caption using a semantic ontology capable of finding object information and attribute information in a new image provided by a user and using the found object information and attribute information to generate a natural language sentence describing the image.

According to an aspect of embodiments of the present invention, an apparatus for automatically generating a domain-specific image caption using a semantic ontology includes: a caption generator configured to generate an image caption in the form of a sentence describing an image provided from a client, in which the client includes a user device, and the caption generator includes a server connected to the user device through a wired/wireless communication method.

The caption generator may find attribute and object information in the image using a deep learning algorithm for the image received from the user device through an image caption generation unit, and use the found information to generate an image caption in the form of a sentence describing the image using a natural language.

The caption generator may generate a semantic ontology for a domain targeted by a user through an ontology generation unit.

The caption generator may replace a specific general word in the caption generated by the image caption generation unit with a domain-specific word through a domain-specific image caption generation unit using results of the image caption generation unit and the ontology generation unit to generate the domain-specific image caption.

When a domain-specific image is input from the user device, in the caption generator, the image caption generation unit may extract attribute and object information for the input image, and generate an image caption in the form of a sentence using the extracted information, the ontology generation unit may extract domain-specific information, which is ontology information related to specific words of the generated image caption, using an ontology generation tool, and a domain-specific image caption generation unit may replace a specific common word with a domain-specific word in the image caption in the form of the sentence using the generated image caption and the domain-specific information that is the extracted ontology information to generate the domain-specific image caption sentence.

Upon receiving the image, the image caption generation unit may extract words most related to the image through attribute extraction and convert each extracted word into a vector representation, extract important objects in the image through object recognition for the image and convert each object area into the vector representation, and use vectors generated through the attribute extraction and object recognition to generate the image caption in the form of the sentence describing the input image.

The image caption generation unit may be trained in advance using a deep-leaming-based object recognition model for object recognition for the image, and extract an object area of a part corresponding to a predefined object set in the input image.

The image caption generation unit may be trained by receiving image caption data tagged with image and grammar information, extract word information related to the image through the attribute extraction of the image from the input image and the image caption data, convert the extracted word information into the vector representation, and calculate a mean of the vectors, extract object area information related to the image through the object recognition of the image and convert the extracted object area information into the vector representation and calculate the mean of the vectors, calculate a word attention score for vectors that are highly related to a word to be generated in a current time step in consideration of a word and a grammar generated in a previous time step for the word vectors obtained through the attribute extraction of the image, calculate an area attention score for area vectors obtained through the object recognition of the image, predict a word and a grammatical tag of the word at the current time step in consideration of all of a mean vector calculated through the generated word attention score and area attention score values and the image attribute extraction process, a mean vector value calculated through the image object recognition process, a word generated in the previous language generation process, and hidden state values for all words previously generated through the language generation process, and compare the predicted word and the grammatical tag of the word with a correct caption sentence to calculate loss values for each of the generated word and the grammatical tag, and reflect the loss values to update learning parameters of the image caption generation process.

The image caption generation unit may be trained in advance using an image-text embedding model based on a deep learning algorithm to extract the attribute for the image, and the image-text embedding model may be a model that maps a plurality of images and words related to each image into one vector space and outputs or extracts words related to a new image when the new image is input, and words related to each image may be extracted in advance using an image caption database and used for learning.

In order to generate the image caption in the form of the sentence, the image caption generation unit may perform an attribute attention process, an object attention process, a grammar learning process, and a language generation process, train these processes using a deep learning algorithm, and generate the sentence based on a recurrent neural network (RNN).

In the attribute attention process, a word attention score may be assigned in order from a word with highest relevance to a word to be generated in the language generation process at a current time step for vectors generated through the attribute extraction of the image, in the object attention process, a word attention score may be assigned in order from an area with highest relevance to a word to be generated in the language generation process at a current time step for vectors generated through the object recognition of the image, and the word attention score and the area attention score may have a value between 0 and 1, with a value closer to 1 being assigned as the relevance to the generated word is higher.

The grammar learning process and the language generation process may use word attention score and area attention score values with one deep learning model, a mean of the vectors generated in the attribute attention process and mean values of the vectors generated in the object attention process to generate a word for a caption and a grammatical tag for the word at each time step.

According to another aspect of embodiments of the present invention, a method of automatically generating a domain-specific image caption using a semantic ontology includes: providing, by a client, an image for generating a caption to a caption generator; and generating, by the caption generator, an image caption in the form of a sentence describing the image provided from the client, in which the client includes a user device, and the caption generator includes a server connected to the user device through a wired/wireless communication method.

In order to generate the image caption in the form of the sentence, the caption generator may find attribute and object information in the image using a deep learning algorithm for the image received from the user device through an image caption generation unit, and use the found information to generate an image caption in the form of a sentence describing the image using a natural language.

In order to generate the image caption in the form of the sentence, the caption generator may generate a semantic ontology for a domain targeted by a user through an ontology generation unit.

In order to generate the image caption in the form of the sentence, the caption generator may replace a specific general word in the caption generated by the image caption generation unit with a domain-specific word through a domain-specific image caption generation unit using results of the image caption generation unit and the ontology generation unit to generate the domain-specific image caption.

When a domain-specific image is input from the user device, in the caption generator, the image caption generation unit may extract attribute and object information for the input image and generate an image caption in the form of a sentence using the extracted information, the ontology generation unit may extract domain-specific information, which is ontology information related to specific words of the generated image caption, using an ontology generation tool, and a domain-specific image caption generation unit may replace a specific general word with a domain-specific word in the image caption in the form of the sentence using the generated image caption and the domain-specific information that is the extracted ontology information to generate the domain-specific image caption sentence.

When a domain-specific image is input from the user device, the image caption generation unit may extract words most related to the image through attribute extraction and convert each extracted word into a vector representation, extract important objects in the image through object recognition for the image and convert each object area into the vector representation, and use vectors generated through the attribute extraction and object recognition to generate the image caption in the form of the sentence describing the input image.

In order to generate the image caption in the form of the sentence describing the image, the image caption generation unit may be trained in advance using a deep-leaming-based object recognition model for object recognition for the image and extract an object area of a part corresponding to a predefined object set in the input image.

In order to generate the image caption in the form of the sentence describing the image, the image caption generation unit may be trained by receiving image caption data tagged with image and grammar information, extract word information related to the image through the attribute extraction of the image from the input image and the image caption data and convert the extracted word information into the vector representation and calculate a mean of the vectors, extract object area information related to the image through the object recognition of the image and convert the extracted object area information into the vector representation and calculate the mean of the vectors, calculate a word attention score for vectors that are highly related to a word to be generated in a current time step in consideration of a word and a grammar generated in a previous time step for the word vectors obtained through the attribute extraction of the image, calculate an area attention score for area vectors obtained through the object recognition of the image, predict a word and a grammatical tag of the word at the current time step in consideration of all of a mean vector calculated through the generated word attention score and area attention score values and the image attribute extraction process, a mean vector value calculated through the image object recognition process, a word generated in the previous language generation process, and hidden state values for all words previously generated through the language generation process, and compare the predicted word and the grammatical tag of the word with a correct answer caption sentence to calculate loss values for each of the generated word and the grammatical tag, and reflect the loss values to update learning parameters of the image caption generation process.

In order to extract the attribute for the image, the image caption generation unit may be trained in advance using an image-text embedding model based on a deep learning algorithm, and the image-text embedding model may be a model that maps a plurality of images and words related to each image into one vector space and outputs or extracts words related to a new image when the new image is input, and words related to each image may be extracted in advance using an image caption database and used for learning.

In order to generate the image caption in the form of the sentence, the image caption generation unit may perform an attribute attention process, an object attention process, a grammar learning process, and a language generation process, train these processes using a deep learning algorithm, and generate the sentence based on a recurrent neural network (RNN).

In the attribute attention process, a word attention score may be assigned in order from a word with highest relevance to a word to be generated in the language generation process at a current time step for vectors generated through the attribute extraction of the image, in the object attention process, a word attention score may be assigned in order from an area with highest relevance to a word to be generated in the language generation process at a current time step for vectors generated through the object recognition of the image, and the word attention score and the area attention score may have a value between 0 and 1, with a value closer to 1 being assigned as the relevance to the generated word is higher.

The grammar learning process and the language generation process may use word attention score and area attention score values with one deep learning model, a mean of the vectors generated in the attribute attention process and mean values of the vectors generated in the object attention process to generate a word for a caption and a grammatical tag for the word at each time step.

### BRIEF DESCRIPTION

Some of the embodiments will be described in detail, with reference to the following figures, wherein like designations denote like members, wherein:

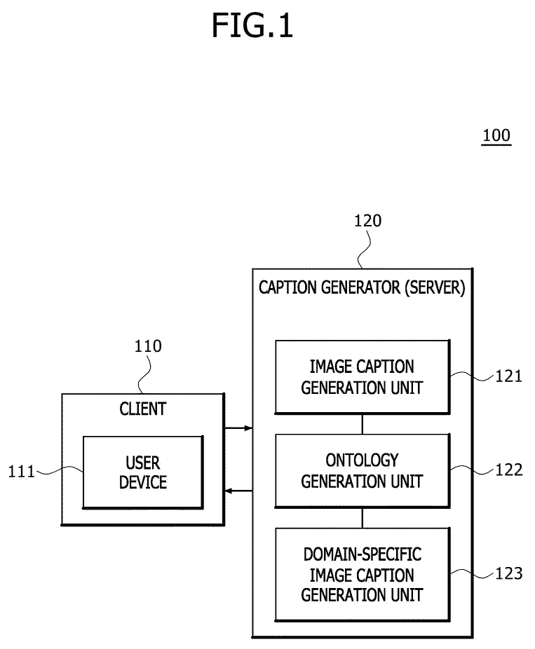

FIG. 1 is an exemplary diagram illustrating a schematic configuration of an apparatus for automatically generating a domain-specific image caption using a semantic ontology according to an embodiment of the present invention;

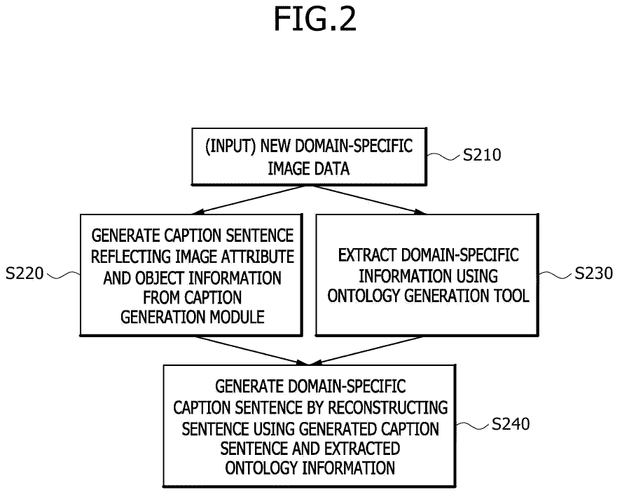

FIG. 2 is a flowchart for describing a method of automatically generating a domain-specific image caption using a semantic ontology according to an embodiment of the present invention;

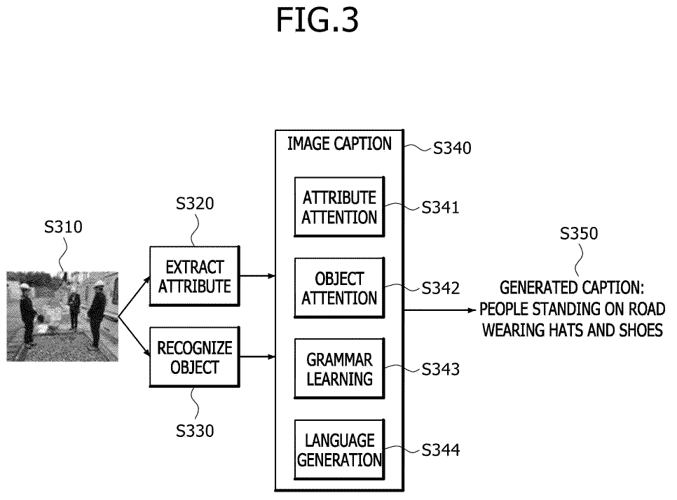

FIG. 3 is a flowchart for describing an operation of an image caption generation unit according to the embodiment in FIG. 1;

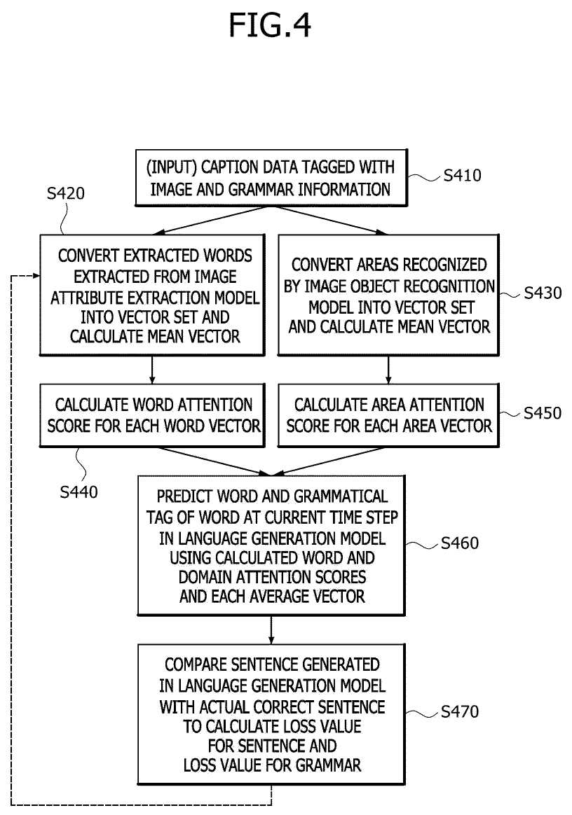

FIG. 4 is a flowchart for describing a method of training an image caption generation unit according to the embodiment in FIG. 1;

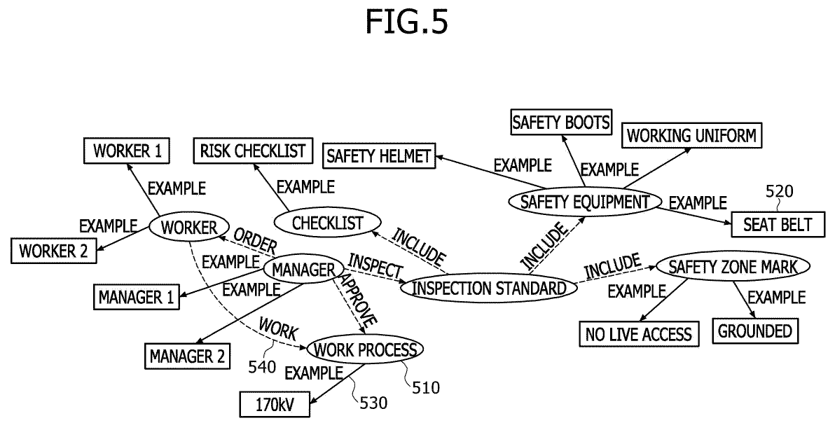

FIG. 5 is an exemplary view illustrating a semantic ontology for a construction site domain generated by an ontology generation unit according to the embodiment in FIG. 1;

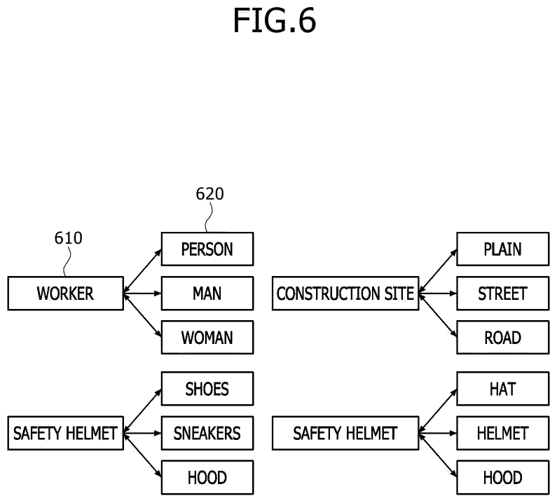

FIG. 6 is an exemplary diagram for describing a domain-general word relation ontology generated by the ontology generation unit according to the embodiment in FIG. 5;

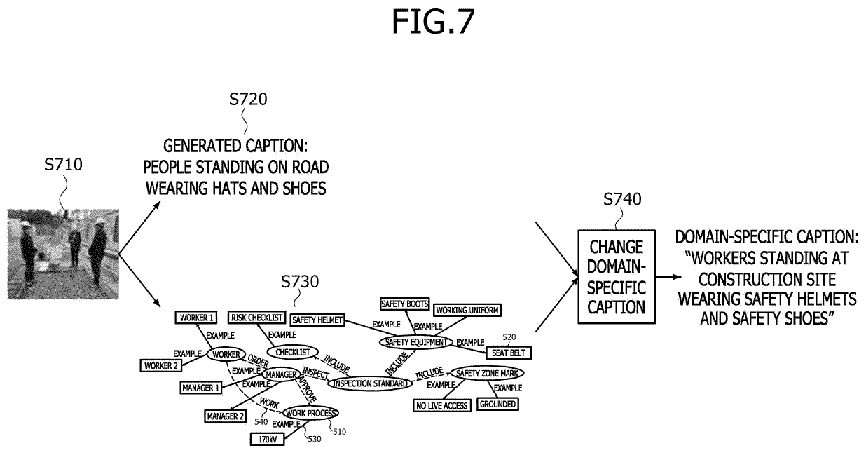

FIG. 7 is an exemplary diagram for describing a process of generating a final result in a domain-specific image caption generation unit according to the embodiment in FIG. 1;

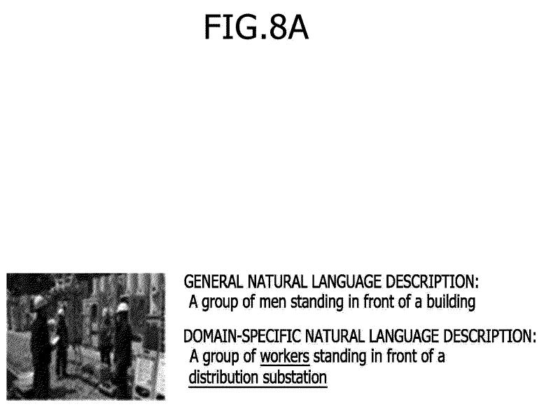

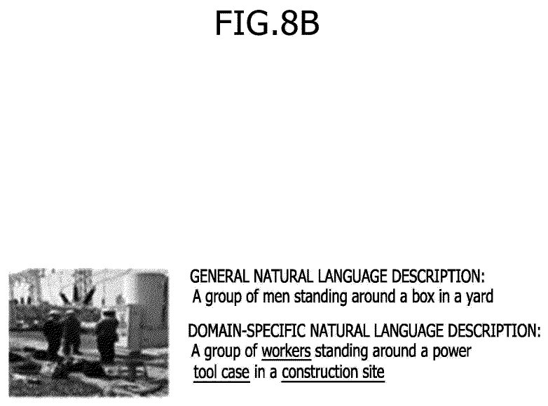

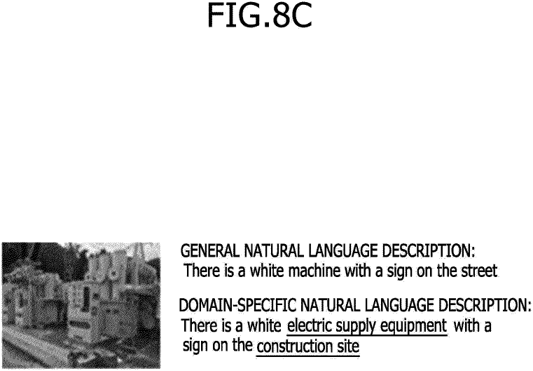

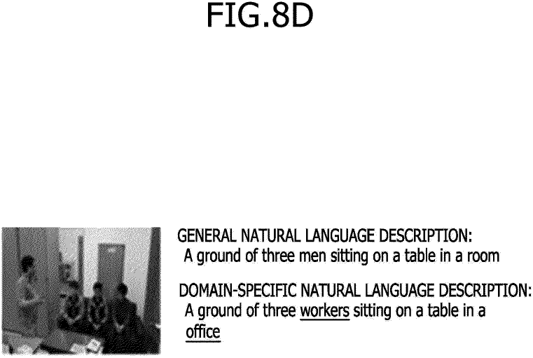

FIG. 8A shows anexemplary diagram illustrating domain-specific image captions in the form of sentences finally generated according to the embodiment in FIG. 7;

FIG. 8B shows an exemplary diagram illustrating domain-specific image captions in the form of sentences finally generated according to the embodiment in FIG. 7;

FIG. 8C shows an exemplary diagram illustrating domain-specific image captions in the form of sentences finally generated according to the embodiment in FIG. 7; and

FIG. 8D shows an exemplary diagram illustrating domain-specific image captions in the form of sentences finally generated according to the embodiment in FIG. 7;

### DETAILED DESCRIPTION

Hereinafter, an embodiment of an apparatus and method for automatically generating a domain-specific image caption using a semantic ontology according to embodiments of the present invention will be described with reference to the accompanying drawings.

In this process, thicknesses of lines, sizes of components, and the like illustrated in the accompanying drawings may be exaggerated for clearness of explanation and convenience. In addition, terms to be described below are defined in consideration of functions in the present disclosure and may be construed in different ways according to the intention of users or practice. Therefore, these terms should be defined on the basis of the content throughout the present specification.

FIG. 1 is an exemplary diagram illustrating a schematic configuration of an apparatus for automatically generating a domain-specific image caption using a semantic ontology according to an embodiment of the present invention.

As illustrated in FIG. 1, an apparatus 100 for automatically generating a domain-specific image caption using a semantic ontology according to the present embodiment includes a client 110 and a caption generator 120. The client 110 and the caption generator 120 are connected through a wired/wireless communication method.

Here, the caption generator 120 (or server) includes an image caption generation unit 121, an ontology generation unit 122, and a domain-specific image caption generation unit 123.

The client 110 is a component that provides an image to be processed (i.e., an image for which a caption is to be generated), and a user provides a picture (i.e., an image) to the caption generator 120 (or server) through the user device 111. In this case, the client 110 includes a user device (e.g., a smart phone, a tablet PC, etc.) 111.

The caption generator 120 generates a caption (i.e., image caption) that describes the image provided from the user (i.e., the user device 111), and returns a basis for the generated caption (i.e., image caption) to the user.

The image caption generation unit 121 finds attribute and object information in an image using a deep learning algorithm for the image received from the user (i.e., the user device 111), and uses the found information (e.g., attribute and object information in the image) to generate a natural language explanatory sentence (e.g., a sentence having a specified format including a subject, a verb, an object, and a complement).

The ontology generation unit 122 generates a semantic ontology for a domain targeted by a user.

For example, the ontology generation unit 122 includes all tools that may build ontology in the form of classes, instances, and relationships (e.g., the protege effect, etc.), and uses the tool for a user to construct domain-specific knowledge into an ontology in advance.

The domain-specific image caption generation unit 123 restructures the caption generated by the image caption generation unit 121 using the results of the image caption generation unit 121 and the ontology generation unit 122 to generate a specific image caption.

FIG. 2 is a flowchart for describing a method of automatically generating a domain-specific image caption using semantic ontology according to an embodiment of the present invention.

Referring to FIG. 2, when a new domain-specific image (i.e., image data) is input to the caption generator 120 from a user (i.e., user device 111) (S210), the image caption generation unit 121 extracts the attribute and object information for the input image, and generates a caption (i.e., image caption) using the extracted information (S220).

In addition, the ontology generation unit 122 extracts ontology information (i.e., domain-specific information) related to specific words of the generated caption (i.e., image caption) using the ontology generation tool (S230).

For reference, it is assumed that specific ontology information for the input image is predefined.

Next, the domain-specific image caption generation unit 123 generates a domain-specific image caption sentence using the generated caption (i.e., image caption) and the extracted ontology information (i.e., domain-specific information) and returns the generated domain-specific image caption sentence to the user (S240).

FIG. 3 is a flowchart for describing an operation of the image caption generation unit in FIG. 1.

Referring to FIG. 3, when the image caption generation unit 121 receives an image (i.e., image data) to generate a caption describing the image (S310), the image caption generation unit 121 extracts words most related to the image through the attribute extraction, and converts each extracted word into a vector representation (S320). In addition, important objects in the image are extracted through the object recognition of the image (i.e., image data), and each object area is converted into a vector representation (S330).

An image caption describing the input image is generated using the vectors generated through the attribute extraction and the object recognition (S340).

In order to generate the image caption, the process of generating the image caption (S340) may include an attribute attention process (S341), an object attention process (S342), a grammar learning process (S343), and a language generation process (S344).

In this case, the processes (S341 to S344) are trained using a deep learning algorithm, and are performed with a time step when predicting each word for an image because the processes (S341 to S344) are based on a recurrent neural network (RNN).

In the attribute attention process (S341), a word attention score is assigned in order from a word with highest relevance to a word to be generated in the language generation process (S344) at a current time step for the vectors generated through the attribute extraction.

In the attribute attention process (S342), an area attention score is assigned in order from an area with highest relevance to a word to be generated in the language generation process (S344) at the current time step for the object areas generated through the object recognition.

In this case, the word attention score and the area attention score have values between 0 and 1, with a value closer to 1 being assigned as the relevance to the generated word is higher.

The grammar learning process (S343) and the language generation process (S344) use the generated word attention score and area attention score values with one deep learning model, a mean of the vectors generated in the attribute attention process (S341), and mean values of the vectors generated in the object attention process (S342) to generate a word for a caption and a grammatical tag for the word at each time step.

Accordingly, the image caption sentence in which the grammar is considered is generated through the image caption process 340 for the input image (S350).

More specifically, the process of extracting an attribute for the image (S320) is a process that is pre-trained before the image caption generation unit 121 is trained, and is trained using an image-text embedding model based on a deep learning algorithm. Here, the image-text embedding model is a model that maps many images and words related to each image into one vector space, and outputs (or extracts) words related to a new image when the new image is input. In this case, words related to each image are extracted in advance using an image caption database (not illustrated) and used for learning.

Meanwhile, the method of extracting words related to images from image caption sentences uses words in a verb form (including a gerund and a participle) in the caption and uses noun-form words that appear identically more than the standard (e.g., three times), for example, when there are 5 captions for each image. The words related to the image extracted in this way are trained to be embedded in one vector space using the deep learning model.

Also, more specifically, similar to the attribute extraction process (S320), the object recognition process (S330) is a process that is pre-trained before the image caption generation unit 121 is trained, and uses a deep-leaming-based object recognition model such as the Mask R-CNN algorithm to extract an area of a part corresponding to a predefined object set in the input image.

FIG. 4 is a flowchart for describing a method of training an image caption generation unit in FIG. 1.

Referring to FIG. 4, the image caption generation unit 121 receives, as an input, image caption data tagged with an image and grammar information for learning (S410).

In the case of the image caption data, the grammar information is annotated in advance for all correct caption sentences using a grammar tagging tool (e.g., EasySRL, etc.) designated before learning starts or the grammar learning process (S343).

In addition, the image caption generation unit 121 extracts word information related to an image through the attribute extraction of the image from the input image and the image caption data, converts the extracted word information into a vector representation, and calculates a mean of the vectors (i.e., mean vector) (S420).

In addition, the image caption generation unit 121 extracts the object area information related to the image through the object recognition of the image, converts the extracted object area information into the vector representation, and calculates the mean (i.e., mean vector) of the vectors (S430).

In addition, the image caption generation unit 121 calculates a word attention score for vectors that are highly related to a word to be generated in a current time step in consideration of a word and a grammar generated in a previous time step for the word vectors obtained through the attribute extraction of the image (S440).

Also, the image caption generation unit 121 calculates an area attention score for area vectors obtained through the object recognition of the image (S450).

In addition, the image caption generation unit 121 predicts a word and a grammatical tag of the word at the current time step in consideration of all of a mean vector calculated through the generated word attention score and area attention score values and the image attribute extraction process, a mean vector value calculated through the image object recognition process, a word generated in the previous language generation process, and hidden state values for all words previously generated through the language generation process (S460).

In addition, the image caption generation unit 121 compares the predicted word and the grammatical tag of the word with the correct caption sentence to calculate loss values for each of the generated word and grammatical tag (S470), and reflects the loss values to update learning parameters of the image caption generation process (S340).

FIG. 5 is an exemplary view illustrating a semantic ontology for a construction site domain generated by an ontology generation unit in FIG. 1.

In the present embodiment, it is assumed that the ontology generation unit 122 generates a domain-specific semantic ontology and a domain-general word relation ontology in advance to provide domain-specific ontology information.

That is, FIG. 5 exemplifies a domain-specific semantic ontology. The domain-specific ontology includes a domain-specific class 510, an instance 520 for a class, a relationship 530 between a class and an instance, and a relationship 540 between classes.

Here, the domain-specific class 510 corresponds to higher classifications that may generate an instance in a specific domain targeted by a user, and may include, for example, “manager,” “worker,” “inspection standard,” and the like in the construction site domain of FIG. 5.

The instance 520 for the class corresponds to an instance of each domain-specific class 510, and for example, “manager” classes such as “manager 1,” “manager 2,” etc. may be generated, and “safety equipment” classes may include instances such as “working uniform,” “safety helmet,” “safety boots,” etc.

The relationship 530 between the class and the instance is information indicating the relationship between the class and the instance generated from the class, and is generally defined as a “case.”

The relationship 540 between the classes is information indicating the relationship between classes defined in the ontology, and for example, the “manager” class has the relationship of “inspect” for the “inspection standard” class.

FIG. 6 is an exemplary diagram for describing a domain-general word relation ontology generated by the ontology generation unit in FIG. 5.

Referring to FIG. 6, the left side of each item represents a domain-specific instance 610 (e.g., worker, safety helmet), and the right item represents an instance 620 for general words.

Here, the domain-specific instance 610 is one of the instances defined in the domain-specific ontology.

Also, the instances 620 for the general words correspond to words in the caption generated by the image caption generation unit 121. That is, the instance 620 for general words may include each word in word dictionaries in a dataset used by the image caption generation unit 121 in the learning operation.

Accordingly, specific words in the general image caption generated by the image caption generation unit 121 may be replaced with domain-specific words using the domain-general word relation ontology 600. That is, when the domain-specific information is extracted from the ontology as described in FIG. 2, as described in FIG. 5, the domain-specific semantic ontology is used.

FIG. 7 is an exemplary diagram for describing a process of generating a final result in a domain-specific image caption generation unit in FIG. 1.

Referring to FIG. 7, when the domain-specific image caption generation unit 123 receives a domain-specific image from the user (S710), the image caption generation unit 121 generates an image caption for the domain-specific image (S720).

In addition, the domain-specific image caption conversion is performed using the ontology predefined through the domain-specific ontology generation unit 122 (S730) to generate the domain-specific image caption (S740). That is, the domain-specific image caption generation unit 123 extracts specific words in the image caption generated by the image caption generation unit 121 and words matching the domain-general word relation ontology, and replaces these specific words (that is, general words) with the related domain-specific words to finally generate the domain-specific image caption.

FIGS. 8A-8D show exemplary diagrams illustrating the domain-specific image caption in the form of the sentence finally generated in FIG. 7.

Referring to FIGS. 8A-8D, the exemplified domain is a construction site domain, and when a general image caption 820 generated by the image caption generation unit 121 is output for a given domain-specific image 810, the domain-specific image caption generation unit 123 replaces specific words (i.e., general words) with the related domain-specific words using the domain-specific ontology information to finally generate and output the domain-specific image captions (830).

For example, in FIG. 8A, the general word “men” is replaced with the domain-specific word “workers,” and the general word “building” is replaced with the domain-specific word “distribution substation,” to finally generate and output the domain-specific image caption. Also in FIGS. 8B to 8D, a general word is replaced with a domain-specific word to finally generate and output the domain-specific image caption.

Although the present invention has been described with reference to embodiments shown in the accompanying drawings, these are only exemplary. It will be understood by those skilled in the art that various modifications and equivalent other exemplary embodiments of the present invention are possible. Accordingly, the true technical scope of embodiments of the present invention are to be determined by the spirit of the appended claims. Implementations described herein may be implemented in, for example, a method or process, an apparatus, a software program, a data stream, or a signal. Although discussed only in the context of a single form of implementation (e.g., discussed only as a method), implementations of the discussed features may also be implemented in other forms (for example, an apparatus or a program). The apparatus may be implemented in suitable hardware, software, firmware, and the like. A method may be implemented in an apparatus such as a processor, which is generally a computer, a microprocessor, an integrated circuit, a processing device including a programmable logic device, or the like. Processors also include communication devices such as a computer, a cell phone, a portable/personal digital assistant (“PDA”), and other devices that facilitate communication of information between end-users.

According to one aspect of embodiments of the present invention, it is possible to find object information and attribute information in a new image provided by a user and use the found object information and attribute information to generate a natural language sentence describing the image.

Although the present invention has been disclosed in the form of preferred embodiments and variations thereon, it will be understood that numerous additional modifications and variations could be made thereto without departing from the scope of the invention.

For the sake of clarity, it is to be understood that the use of “a” or “an” throughout this application does not exclude a plurality, and “comprising” does not exclude other steps or elements. The mention of a “unit” or a “module” does not preclude the use of more than one unit or module.

1. An apparatus for automatically generating a domain-specific image caption using a semantic ontology, the apparatus comprising:
a caption generator configured to generate an image caption in a form of a sentence describing an image provided from a client,
wherein the client includes a user device, and
wherein the caption generator includes a server connected to the user device through a wired/wireless communication method.

2. The apparatus of claim 1, wherein the caption generator finds attribute and object information in the image using a deep learning algorithm for the image received from the user device through an image caption generation unit, and
uses the found information to generate an image caption in a form of a sentence describing the image using a natural language.

3. The apparatus of claim 1, wherein the caption generator generates a semantic ontology for a domain targeted by a user through an ontology generation unit.

4. The apparatus of claim 2, wherein the caption generator replaces a specific general word in the caption generated by the image caption generation unit with a domain-specific word through a domain-specific image caption generation unit using results of the image caption generation unit and the ontology generation unit to generate the domain-specific image caption.

5. The apparatus of claim 1, wherein, when a domain-specific image is input from the user device, in the caption generator,
an image caption generation unit extracts attribute and object information for the input image, and generates an image caption in a form of a sentence using the extracted information,
an ontology generation unit extracts domain-specific information, which is ontology information related to specific words of the generated image caption, using an ontology generation tool, and
a domain-specific image caption generation unit replaces a specific general word with a domain-specific word in the image caption in the form of the sentence using the generated image caption and the domain-specific information that is the extracted ontology information to generate the domain-specific image caption sentence.

6. The apparatus of claim 2, wherein, upon receiving the image, the image caption generation unit extracts words most related to the image through attribute extraction and converts each extracted word into a vector representation,
extracts important objects in the image through object recognition for the image and converts each object area into the vector representation, and
uses vectors generated through the attribute extraction and object recognition to generate the image caption in the form of the sentence describing the input image.

7. The apparatus of claim 6, wherein the image caption generation unit is trained in advance using a deep-learning-based object recognition model for object recognition for the image, and
extracts an object area of a part corresponding to a predefined object set in the input image.

8. The apparatus of claim 6, wherein the image caption generation unit is trained by receiving image caption data tagged with image and grammar information,
extracts word information related to the image through the attribute extraction of the image from the input image and the image caption data, converts the extracted word information into the vector representation, and calculates a mean of the vectors,
extracts object area information related to the image through the object recognition of the image, converts the extracted object area information into the vector representation, and calculates the mean of the vectors,
calculates a word attention score for vectors that are highly related to a word to be generated in a current time step in consideration of a word and a grammar generated in a previous time step for the word vectors obtained through the attribute extraction of the image,
calculates an area attention score for area vectors obtained through the object recognition of the image,
predicts a word and a grammatical tag of the word at the current time step in consideration of all of a mean vector calculated through the generated word attention score and area attention score values and the image attribute extraction process, a mean vector value calculated through the image object recognition process, a word generated in the previous language generation process, and hidden state values for all words previously generated through the language generation process, and
compares the predicted word and the grammatical tag of the word with a correct caption sentence to calculate loss values for each of the generated word and the grammatical tag, and reflects the loss values to update learning parameters of the image caption generation process.

9. The apparatus of claim 6, wherein the image caption generation unit is trained in advance using an image-text embedding model based on a deep learning algorithm to extract the attribute for the image, and
the image-text embedding model is a model that maps a plurality of images and words related to each image into one vector space and outputs or extracts words related to a new image when the new image is input, and words related to each image are extracted in advance using an image caption database and used for learning.

10. The apparatus of claim 6, wherein, in order to generate the image caption in the form of the sentence, the image caption generation unit performs an attribute attention process, an object attention process, a grammar learning process, and a language generation process, trains these processes using a deep learning algorithm, and generates the sentence based on a recurrent neural network (RNN).

11. The apparatus of claim 10, wherein, in the attribute attention process, a word attention score is assigned in order from a word with highest relevance to a word to be generated in the language generation process at a current time step for vectors generated through the attribute extraction of the image,
in the object attention process, a word attention score is assigned in order from an area with highest relevance to a word to be generated in the language generation process at a current time step for vectors generated through the object recognition of the image, and
the word attention score and the area attention score have a value between 0 and 1, with a value closer to 1 being assigned as the relevance to the generated word is higher.

12. The apparatus of claim 10, wherein the grammar learning process and the language generation process use word attention score and area attention score values with one deep learning model, a mean of the vectors generated in the attribute attention process and mean values of the vectors generated in the object attention process to generate a word for a caption and a grammatical tag for the word at each time step.

13. A method of automatically generating a domain-specific image caption using a semantic ontology, the method comprising:
providing, by a client, an image for generating a caption to a caption generator; and
generating, by the caption generator, an image caption in a form of a sentence describing the image provided from the client,
wherein the client includes a user device, and
wherein the caption generator includes a server connected to the user device through a wired/wireless communication method.

14. The method of claim 13, wherein, in order to generate the image caption in the form of the sentence, the caption generator finds attribute and object information in the image using a deep learning algorithm for the image received from the user device through an image caption generation unit, and
uses the found information to generate an image caption in a form of a sentence describing the image using a natural language.

15. The method of claim 13, wherein, in order to generate the image caption in the form of the sentence, the caption generator generates a semantic ontology for a domain targeted by a user through an ontology generation unit.

16. The method of claim 13, wherein, in order to generate the image caption in the form of the sentence, the caption generator replaces a specific general word in the caption generated by an image caption generation unit with a domain-specific word through a domain-specific image caption generation unit using results of the image caption generation unit and an ontology generation unit to generate the domain-specific image caption.

17. The method of claim 13, wherein, when a domain-specific image is input from the user device,
in the caption generator, an image caption generation unit extracts attribute and object information for the input image and generates an image caption in a form of a sentence using the extracted information,
an ontology generation unit extracts domain-specific information, which is ontology information related to specific words of the generated image caption, using an ontology generation tool, and
a domain-specific image caption generation unit replaces a specific general word with a domain-specific word in the image caption in the form of the sentence using the generated image caption and the domain-specific information that is the extracted ontology information to generate the domain-specific image caption sentence.

18. The method of claim 14, wherein, when a domain-specific image is input from the user device,
the image caption generation unit extracts words most related to the image through attribute extraction and converts each extracted word into a vector representation,
extracts important objects in the image through object recognition for the image and converts each object area into the vector representation, and
uses vectors generated through the attribute extraction and object recognition to generate the image caption in the form of the sentence describing the input image.

19. The method of claim 18, wherein, in order to generate the image caption in the form of the sentence describing the image,
the image caption generation unit is trained in advance using a deep-learning-based object recognition model for object recognition for the image, and
extracts an object area of a part corresponding to a predefined object set in the input image.

20. The method of claim 18, wherein, in order to generate the image caption in the form of the sentence describing the image,
the image caption generation unit is trained by receiving image caption data tagged with image and grammar information,
extracts word information related to the image through the attribute extraction of the image from the input image and the image caption data and converts the extracted word information into the vector representation, and calculates a mean of the vectors,
extracts object area information related to the image through the object recognition of the image and converts the extracted object area information into the vector representation, and calculates the mean of the vectors,
calculates a word attention score for vectors that are highly related to a word to be generated in a current time step in consideration of a word and a grammar generated in a previous time step for the word vectors obtained through the attribute extraction of the image,
calculates an area attention score for area vectors obtained through the object recognition of the image,
predicts a word and a grammatical tag of the word at the current time step in consideration of all of a mean vector calculated through the generated word attention score and area attention score values and the image attribute extraction process, a mean vector value calculated through the image object recognition process, a word generated in the previous language generation process, and hidden state values for all words previously generated through the language generation process, and
compares the predicted word and the grammatical tag of the word with a correct answer caption sentence to calculate loss values for each of the generated word and the grammatical tag, and reflects the loss values to update learning parameters of the image caption generation process.

21. The method of claim 18, wherein, in order to extract the attribute for the image, the image caption generation unit is trained in advance using an image-text embedding model based on a deep learning algorithm, and
the image-text embedding model is a model that maps a plurality of images and words related to each image into one vector space and outputs or extracts words related to a new image when the new image is input, and words related to each image are extracted in advance using an image caption database and used for learning.

22. The method of claim 18, wherein, to generate the image caption in the form of the sentence, the image caption generation unit performs an attribute attention process, an object attention process, a grammar learning process, and a language generation process, and trains these processes using a deep learning algorithm, and
generates the sentence based on a recurrent neural network (RNN).

23. The method of claim 22, wherein, in the attribute attention process, a word attention score is assigned in order from a word with highest relevance to a word to be generated in the language generation process at a current time step for vectors generated through the attribute extraction of the image,
in the object attention process, a word attention score is assigned in order from an area with highest relevance to a word to be generated in the language generation process at a current time step for vectors generated through the object recognition of the image, and
the word attention score and the area attention score have a value between 0 and 1, with a value closer to 1 being assigned as the relevance to the generated word is higher.

24. The method of claim 22, wherein the grammar learning process and the language generation process use word attention score and area attention score values with one deep learning model, a mean of the vectors generated in the attribute attention process and mean values of the vectors generated in the object attention process to generate a word for a caption and a grammatical tag for the word at each time step.
